(19) United States
(12) Patent Application Publication
(10) Pub. No.: US 2015/0212578 A1
(43) Pub. Date: Jul. 30, 2015

(54) Touch Implement with Haptic Feedback for Simulating Surface Texture

(71) Applicant: Apple Inc., Cupertino, CA (US)

(72) Inventors: Jason Lor, San Francisco, CA (US); Patrick A. Carroll, San Francisco, CA (US); Dustin J. Verhoeve, San Francisco, CA (US)

(73) Assignee: Apple Inc., Cupertino, CA (US)

(21) Appl. No.: 14/165,488

(22) Filed: Jan. 27, 2014

(51) Int. Cl. G06F 3/01; G06F 3/0354

(52) U.S. Cl. CPC G06F 3/016; G06F 3/03547

(57) ABSTRACT

A touch implement may include one or more controllers coupled to one or more haptic devices and one or more sensors that detect when the touch implement contacts a surface. The controller may provide haptic feedback via the haptic device(s) to simulate a texture of the surface when the touch implement is in contact. In some cases the texture may correspond to a texture displayed on the surface whereas in other implementations the texture may be unrelated to the appearance of the surface. In some implementations, the touch implement may detect information about the texture of the surface or information encoded in surface about texture or haptic feedback to provide and adjust haptic feedback accordingly. In other implementations, the touch implement may receive transmitted information regarding the texture or haptic feedback to provide and adjust haptic feedback accordingly.

### TECHNICAL FIELD

This disclosure relates generally to touch implements, and more specifically to a touch implement that provides haptic feedback to simulate a surface texture.

### BACKGROUND

A variety of different touch implements exist for providing input by contacting a surface. For example, a stylus may be utilized to provide input by contacting a display surface of an electronic device. In some cases, such display surfaces may be touch screens.

Many touch screens may provide haptic feedback to a user. For example, one or more vibration devices located under the touch screen of an electronic device may provide haptic feedback to a user by way of vibrations when the user is touching the touch screen. Such vibrations may be utilized to convey a variety of different information to a user, such as information regarding one or more touch inputs that a user has provided, alerts, status of the electronic device or one or more applications executing thereupon, and/or any other such information.

However, haptic feedback provided via devices in a display surface may not convey information adequately to a user when a stylus or other touch implement is utilized. In such a case, the user is not directly touching the surface. The user may thus not perceive the haptic feedback provided on the surface.

### SUMMARY

The present disclosure discloses systems and methods for simulating texture of a surface via haptic feedback from a touch implement. A touch implement, such as a stylus, may include one or more controllers coupled to one or more haptic devices and one or more sensors that detect when the touch implement contacts a surface. The controller may provide haptic feedback via the haptic device(s) to simulate a texture of the surface when the touch implement is in contact. In some cases the texture may correspond to a texture displayed on the surface whereas in other implementations the texture may be unrelated to the appearance of the surface.

In some implementations, the touch implement may detect information about the texture of the surface or information encoded in surface about texture or haptic feedback to provide and adjust haptic feedback accordingly. In other implementations, such as where the surface is a display and/or touch screen of an electronic device, the touch implement may receive transmitted information regarding the texture or haptic feedback to provide and adjust haptic feedback accordingly.

In some implementations, the haptic device(s) may be one or more vibration devices. In such implementations, the touch device may cause the vibration device(s) to vibrate more strongly to simulate rougher textures and/or lighter to simulate smoother textures. In various implementations, the touch implement may vary the provided feedback as the touch implement is moved across the surface. In some cases, the sensor may be operable to detect the amount of pressure with which the touch implement is pressed against the surface and the provided haptic feedback may be dependent thereon. In some various, the touch implement may also include one or more orientation detectors that determine an orientation of the touch implement with respect to the surface and the touch implement may adjust the texture simulated based upon the orientation.

In one or more implementations, a touch implement may include at least one controller; at least one haptic device coupled to at least one controller; and at least one sensor, coupled to the at least one controller, that detects when the touch implement contacts a surface. The at least one controller may provide haptic feedback via the at least one haptic device to simulate a texture of the surface when the touch implement contacts the surface.

In some implementations, a system for simulating texture of a surface via haptic feedback from a touch implement may include an electronic device with at least one touch surface and a touch implement. The touch implement may include at least one controller; at least one haptic device coupled to at least one controller; and at least one sensor, coupled to the at least one controller, that detects when the touch implement contacts the at least one touch surface. The at least one controller may provide haptic feedback via the at least one haptic device to simulate a texture of the at least one touch surface when the touch implement contacts the at least one touch surface.

In various implementations, a method for simulating texture of a surface via haptic feedback from a touch implement may include detecting that a touch implement contacts a surface utilizing at least one control unit of the touch implement; determining a texture to simulate for the surface utilizing the at least one control unit of the touch implement; and providing haptic feedback via at least one haptic device of the touch implement utilizing the at least one control unit to simulate the texture for the surface.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is an isometric view of an example system for simulating texture of a surface via haptic feedback from a touch implement.

FIG. 2 is a block diagram illustrating an example of a touch implement. This touch implement may be utilized with the system of FIG. 1.

FIG. 3 is a flow chart illustrating an example method for simulating texture of a surface via haptic feedback from a touch implement. This method may be performed by the system of FIG. 1 and/or the touch implement of FIG. 2.

### DETAILED DESCRIPTION

The description that follows includes sample systems, methods, and computer program products that embody various elements of the present disclosure. However, it should be understood that the described disclosure may be practiced in a variety of forms in addition to those described herein.

The present disclosure discloses systems and methods for simulating texture of a surface via haptic feedback from a touch implement. A touch implement, such as a stylus, may include one or more controllers coupled to one or more haptic devices (such as one or more vibration devices, linear vibrators, speakers, and/or other haptic devices) and one or more sensors (such as a contact sensor, a capacitive sensor, a touch sensor, a camera, a piezoelectric sensor, a pressure sensor, a photodiode, and/or other sensor) that detect when the touch implement contacts a surface. The controller may provide haptic feedback via the haptic device(s) to simulate a texture of the surface when the touch implement is in contact. In some cases the texture may correspond to a texture displayed on the surface whereas in other implementations the texture may be unrelated to the appearance of the surface.

In some implementations, the touch implement may detect information about the texture of the surface or information encoded in surface (such as where the surface is a display and/or touch screen of an electronic device) about texture or haptic feedback to provide and adjust haptic feedback accordingly. In other implementations, such as where the surface is a display and/or touch screen of an electronic device, the touch implement may receive transmitted information regarding the texture or haptic feedback to provide and adjust haptic feedback accordingly.

In various implementations, the touch implement may vary the provided feedback as the touch implement is moved across the surface. In various cases, the sensor may be operable to detect the amount of pressure with which the touch implement is pressed against the surface and the provided haptic feedback may be dependent thereon (such as stronger feedback in response to harder pressure and lighter feedback in response to softer pressure). In some cases, the touch implement may also include one or more orientation detectors (such as one or more gyroscopes, accelerometers, and so on) that determine an orientation of the touch implement with respect to the surface and the touch implement may adjust the texture simulated based upon the orientation.

In some implementations, the haptic device(s) may be one or more vibration devices. In such implementations, the touch device may cause the vibration device(s) to vibrate more strongly to simulate rougher textures and/or lighter to simulate smoother textures.

For example, in a case where the touch implement is a stylus, linear vibrators that vibrate in directions opposite from each other (such as one that vibrates up and down and the other side to side) may be positioned at first and second ends of the stylus. The points at which the linear vibrators are positioned may correspond to points where a user's hand may contact the stylus during use. In this way, the stylus may be able to simulate a wide variety of textures due to all of the different vibration combinations available by controlling the respective linear vibrators. Such textural simulation possibilities may be increased with the inclusion of further vibration devices (such as additional linear vibrators that vibrate in still other directions) such as in the tip of the stylus or at other positions.

In some cases, one or more cushion elements may be positioned on the touch implement where the touch implement may contact the surface. In this way, the surface may be isolated from any haptic feedback provided by the haptic feedback device(s).

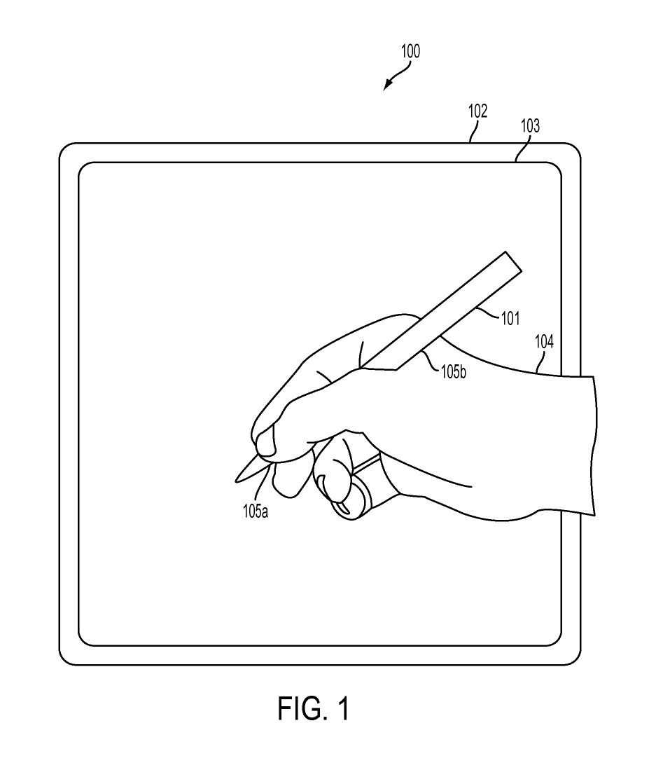

FIG. 1 is an isometric view of an example system for simulating texture of a surface via haptic feedback from a touch implement. The system 100 may include a touch implement 101 and a surface 103.

As illustrated, the touch implement 101 may be a stylus held by the hand 104 of a user. However, it is understood that this is an example. In various implementations, the touch implement may be any kind of touch implement that is operable in any way by a user.

As also illustrated, the surface 103 may be the display and/or touch screen of an electronic device. However, it is understood that this is an example. In various implementations, the surface may be any kind of surface on which a touch implement may be used. Further, although the electronic device is illustrated as a tablet computing device, this is also an example. In various cases, such an electronic device may be any electronic device such as a laptop computing device, a desktop computing device, a wearable device, a mobile computing device, a tablet computing device, a display, a television, a cellular telephone, a smart phone, a digital media player, and/or any other electronic device.

The touch implement 101 may include one or more sensors that detect when the touch implement contacts the surface 103. Such sensors may include one or more contact sensors, capacitive sensors, touch sensors, cameras, piezoelectric sensors, pressure sensors, photodiodes, and/or other sensors operable to detect contact with the surface. The touch implement may also include one or more haptic devices. Such haptic devices may include one or more vibration devices, linear vibrators, speakers, and/or other haptic devices. When the touch implement contacts the surface, the touch implement may provide haptic feedback via the haptic feedback device(s) to simulate a texture of the surface.

In some cases, the simulated texture may correspond to a texture displayed on the surface 103. For example, a rougher texture may be simulated when the touch implement 101 contacts a portion of a display depicting sandpaper and a smoother texture may be simulated when the touch implement contacts a portion of the display depicting glass. However, in other cases the simulated texture may not correspond to a texture displayed on the surface. For example, a stylus may simulate the texture of writing on parchment regardless of what kind of surface the stylus contacts.

In various cases, the touch implement 101 may detect information about the surface or information encoded in the surface and adjust the haptic device(s) to provide feedback to simulate accordingly. For example, a touch implement may utilize a photodiode or other sensor to detect that the surface depicts a wood surface and provide haptic feedback to simulate the grain of a wood texture. By way of another example, a touch implement may utilize a camera or other sensor to detect pixel information encoded in a surface (which may not be visually perceptible to a user) that specifies a particular haptic profile to output and the touch implement may provide haptic feedback accordingly. Such a specified haptic profile may precisely specify the haptic feedback to provide or may be a reference that the touch implement looks up in a storage medium to obtain the specific haptic feedback to provide.

In other cases, the touch implement 101 may receive the information about the surface or the haptic profile information from an electronic device associated with the surface utilizing one or more communication components (such as one or more wired or wireless components, WiFi components, near field communication components, Bluetooth components, and/or other communication components). Such received information may specify the texture to simulate, the haptic profile to provide, a code that may be looked up in a storage medium to determine the haptic profile to provide, and so on.

In various implementations, the texture may correspond to a surface other than the one currently contacted. For example, the touch implement 101 may be able to receive information regarding a texture to “sample,” such as by being told to sample while the touch implement is contacting a surface. In such a case, the touch implement may then detect or obtain texture information from a currently contacted first surface and may store such information in the non-transitory storage medium 107. Subsequently, when the touch implement is contacting a second surface, the touch implement may provide haptic feedback to simulate the texture of the first surface utilizing the stored information.

For example, the touch implement 101 may receive input from a user indicating to “sample” the texture of carpeting that the user is contacting with the touch implement. The touch implement may detect and store information regarding the texture of the carpeting. Subsequently, when the touch implement is contacting a glass surface, the touch implement may provide haptic feedback to simulate the texture of the carpeting utilizing the stored information.

In one or more implementations, a simulated texture may correspond to one or more colors displayed on the surface 103 in addition to and/or instead of a texture displayed on the surface. For example, the touch implement 101 may store information associating a rough texture with the color red and a smooth texture with the color green. When the portion of the surface contacted by the touch implement is red, the touch implement may provide haptic feedback simulating the rough texture. Similarly, when the portion of the surface contacted by the touch implement is green, the touch implement may provide haptic feedback simulating the smooth texture.

In various implementations, the touch implement 101 may simulate textures associated with one or more graphical elements displayed on the surface 103 as opposed to a displayed texture or color. By way of a first example, a number of graphical windows may be displayed on the surface. When the touch implement is moved across the surface to a border of such a window, the touch implement may provide haptic feedback to simulate the touch implement tapping a wall.

By way of a second example, a number of graphical buttons may be displayed on the surface and each may be associated with a function. A texture may be associated with each function and the touch implement 101 may provide haptic feedback to simulate the respective texture when hovering over and/or contacting a respective button. In one non-limiting example case provided for the purpose of illustration, the texture of molasses may be associated with opening a file or web page and the texture of steel wool may be associated with deleting a file. When the touch implement hovers over and/or contacts a button associated with opening a file or web page in this non-limiting example case, the touch implement may provide haptic feedback to simulate the molasses texture. Similarly, when the touch implement hovers over and/or contacts a button associated with deleting a file in this non-limiting example case, the touch implement may provide haptic feedback to simulate the steel wool texture.

In some cases, the touch implement 101 may vary the provided haptic feedback. For example, the haptic feedback may be varied as the touch implement is moved across the surface 101, such as to simulate different textural areas and/or to simulate transition between different textures. By way of another example, a pressure sensor of the touch implement may detect how much pressure the touch implement is contacted to the surface with and the touch implement may adjust the haptic feedback based upon the amount of pressure used. In still another example, an orientation sensor may detect an orientation of the touch implement with respect to the surface and the touch implement may adjust the haptic feedback to correspond to the relationship between the orientation of the touch implement to the surface and the texture simulated.

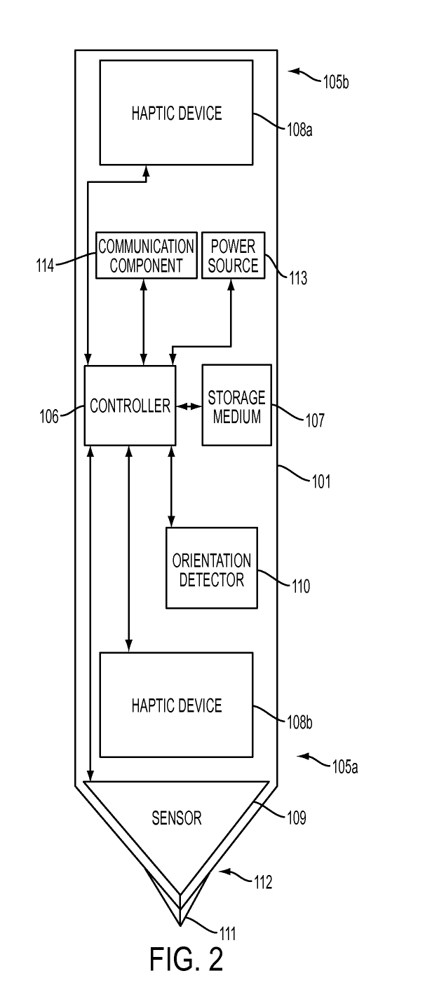

FIG. 2 is a block diagram illustrating an example of a touch implement 101. This touch implement may be utilized with the system 100 of FIG. 1.

As illustrated, the touch implement 101 may include one or more control units 106, one or more non-transitory storage media 107 (which may take the form of, but is not limited to, a magnetic storage medium; optical storage medium; magneto-optical storage medium; read only memory; random access memory; erasable programmable memory; flash memory; and so on), one or more haptic devices 108a and 108b (such as one or more vibration devices, linear vibrators, speakers, and/or other haptic devices), one or more sensors 109 (one or more contact sensors, capacitive sensors, touch sensors, cameras, piezoelectric sensors, pressure sensors, photodiodes, and/or other sensors), one or more orientation detectors 110 (such as one or more gyroscopes, accelerometers, combinations thereof, and/or other such orientation detectors), cushion elements 111 (such as foam and/or other cushioning and/or isolating materials), one or more communication components 114 (such as one or more wired or wireless components, WiFi components, near field communication components, Bluetooth components, and/or other communication components) (which may include one or more radio frequency elements such as one or more antennas), and/or one or more power sources 113 (such as one or more batteries and/or power management units).

In various implementations, the controller 106 may execute one or more instructions stored in the non-transitory storage medium 107 to perform one or more touch implement 101 functions. For example, the non-transitory storage medium may store one or more haptic profiles that the touch implement may utilize to simulate one or more textures. In some cases, the touch implement may retrieve a specific haptic profile utilizing one or more references and/or other codes detected from a surface utilizing the sensor 109 and/or received from an electronic device associated with the surface via the communication component 114.

In one or more example implementations, the touch implement 101 may be a stylus as shown with a tip 112, a first end 105a, a first haptic device 108b positioned at the first end, a second end 105b, and a second haptic device 108a positioned at the second end. The first haptic device may be a linear vibrator that vibrates left to right with respect to the stylus as shown and the second haptic device may be a linear vibrator that vibrates oppositely, up and down with respect to the stylus as shown. The positions of the first and second linear vibrators may correspond to contact points where the user's hand 104 will touch the stylus during use, as shown in FIG. 1. In this way, the stylus may be able to simulate a wide variety of textures via all the different vibration patterns possibly by controlling the first and/or second linear vibrator.

In such a case, with reference again to FIG. 2, the cushion element 111 may operate to isolate a contacted surface from any vibrations provided utilizing the first and/or second linear vibrator.

Further, although a specific example including first and second linear vibrators 108a and 108b positioned at first and second ends 105 and 105b of a stylus touch implement 101 have been described, it is understood that this is an example. In various implementations, other numbers of other kinds of haptic devices may be utilized in other kinds of touch implements without departing from the scope of the present disclosure. For example, in some cases, three vibration devices may be positioned in a stylus (one at each end and one in the tip 112) in order to enable even greater textural simulation range. Further, one or more speakers (and/or other types of haptic devices) may be included for providing the sound of the stylus moving across the particular texture for increased verisimilitude. Other configurations are possible and contemplated.

Additionally, though the touch implement 101 is illustrated in FIG. 2 and described above as including particular components, it is understood that this is an example. In various cases, various configurations of the same, similar, and/or different components may be utilized without departing from the scope of the present disclosure. For example, some implementations may not include a non-transitory storage medium 107. Further, various implementations the touch implement may include one or more biometric readers and/or other components.

Moreover, although the power source 113 is shown connected only to the control unit 106, it is understood that this is a simplified diagram provided for the purpose of example. In various implementations, the power source (such as a battery and power management unit) may be connected to the haptic devices 108a and 108b, the communication component 114, the non-transitory storage medium 107, the orientation detector 110, and/or the sensor 109.

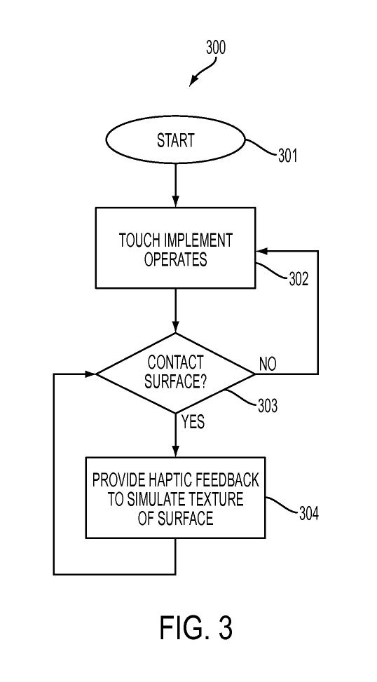

FIG. 3 is a flow chart illustrating an example method 300 for simulating texture of a surface via haptic feedback from a touch implement. This method may be performed by the system 100 of FIG. 1 and/or the touch implement 101 of FIG. 2.

The flow begins at block 301 and proceeds to block 302 where a touch implement operates. The flow then proceeds to block 303 where the touch implement determines whether or not a surface has been contacted. If so, the flow proceeds to block 304. Otherwise, the flow returns to block 302 where the touch device continues to operate.

At block 304, after the touch implement determines that a surface has been contacted, the touch implement provides haptic feedback to simulate a texture of the surface. The flow then proceeds to block 303 where the touch implement determines whether or not a surface has been contacted.

Although the example method 300 is illustrated and described as including particular operations performed in a particular order, it is understood that this is an example. In various implementations, various combinations of the same, similar, and/or different operations may be performed without departing from the scope of the present disclosure.

For example, the example method 300 is illustrated and described in blocks 303 and 304 as providing haptic feedback to simulate the texture of a surface whenever a surface as contacted. However, in various implementations the method may include determining a texture to simulate. Such a determination may include determining a texture depicted on the surface, determining textural or other information encoded in the surface, receiving textural or other information related to haptic feedback to provide from an electronic device associated with the surface, looking up textural or other information related to haptic feedback to provide in one or more non-transitory storage media, and/or other such operations.

By way of another example, the example method 300 is illustrated and described in blocks 303 and 304 as providing haptic feedback to simulate the texture of a surface whenever a surface as contacted. However, in various implementations the method may include varying the haptic feedback over time. Such variation may be dependent on particular textural areas being simulated, changes between different textures being simulated, movement of the touch implement across the surface, pressure with which the touch implement is contacted to the surface, orientation of the touch implement with respect to the surface, and/or any other such reason for varying the texture simulated.

As discussed about and as illustrated in the accompanying figures, the present disclosure discloses systems and methods for simulating texture of a surface via haptic feedback from a touch implement. A touch implement, such as a stylus, may include one or more controllers coupled to one or more haptic devices and one or more sensors that detect when the touch implement contacts a surface. The controller may provide haptic feedback via the haptic device(s) to simulate a texture of the surface when the touch implement is in contact.

In some cases the texture may correspond to a texture displayed on the surface whereas in other implementations the texture may be unrelated to the appearance of the surface. In some implementations, the touch implement may detect information about the texture of the surface or information encoded in surface about texture or haptic feedback to provide and adjust haptic feedback accordingly. In other implementations, such as where the surface is a display and/or touch screen of an electronic device, the touch implement may receive transmitted information regarding the texture or haptic feedback to provide and adjust haptic feedback accordingly.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. A touch implement, comprising:
at least one controller;
at least one haptic device coupled to at least one controller; and
at least one sensor, coupled to the at least one controller, that detects when the touch implement contacts a surface;
wherein the at least one controller provides haptic feedback via the at least one haptic device to simulate a texture of the surface when the touch implement contacts the surface.

2. The touch implement of claim 1, wherein the at least one controller determines the texture to simulate based on information detected about the surface by the at least one sensor.

3. The touch implement of claim 1, wherein the surface is at least one touch surface of an electronic device.

4. The touch implement of claim 3, wherein the at least one controller determines the texture to simulate based on information received from the electronic device.

5. The touch implement of claim 4, wherein the electronic device displays the information on the at least one touch surface and the information is detected by the at least one sensor.

6. The touch implement of claim 4, wherein the at least one controller receives the information from the electronic device utilizing at least one communication component.

7. The touch implement of claim 1, wherein the at least one haptic device comprises at least one of at least one vibration device.

8. The touch implement of claim 7, wherein the at least one controller causes the at least one vibration device to vibrate stronger to simulate a rougher texture and weaker to simulate a smoother texture.

9. The touch implement of claim 1, wherein the touch implement comprises a stylus.

10. The touch implement of claim 9, wherein the at least one haptic device comprises:
at least a first vibration device positioned at a first end of the stylus; and
a second vibration device positioned at a second end of the stylus.

11. The touch implement of claim 10, wherein the first vibration device and the second vibration device comprise linear vibrators that are configured to vibrate in different directions from each other.

12. The touch implement of claim 10, wherein the first vibration device and the second vibration device are each positioned at points where a user contacts the touch implement.

13. The touch implement of claim 1, further comprising:
a cushion element positioned on the touch implement where the touch implement contacts the surface that isolates the surface from the haptic feedback.

14. The touch implement of claim 1, wherein the texture corresponds to a displayed texture of the surface.

15. The touch implement of claim 1, further comprising:
at least one orientation detector for detecting an orientation of the touch implement with respect to the surface;
wherein the haptic feedback provided by the at least one controller is dependent upon the detected orientation.

16. The touch implement of claim 1, further comprising:
at least one pressure sensor that detects a pressure with which the touch implement contacts the surface;
wherein the haptic feedback provided by the at least one controller is dependent upon the detected pressure.

17. The touch implement of claim 1, wherein the at least one sensor comprises at least one of a contact sensor, a capacitive sensor, a touch sensor, a camera, a piezoelectric sensor, a pressure sensor, or a photodiode.

18. The touch implement of claim 1, wherein the at least one controller varies the haptic feedback as the touch implement is moved across the surface.

19. A system for simulating texture of a surface via haptic feedback from a touch implement, comprising:
an electronic device with at least one touch surface; and
a touch implement, comprising:
at least one controller;
at least one haptic device coupled to at least one controller; and
at least one sensor, coupled to the at least one controller, that detects when the touch implement contacts the at least one touch surface;
wherein the at least one controller provides haptic feedback via the at least one haptic device to simulate a texture of the at least one touch surface when the touch implement contacts the at least one touch surface.

20. A method for simulating texture of a surface via haptic feedback from a touch implement, the method comprising:
detecting that a touch implement contacts a surface utilizing at least one control unit of the touch implement;
determining a texture to simulate for the surface utilizing the at least one control unit of the touch implement; and
providing haptic feedback via at least one haptic device of the touch implement utilizing the at least one control unit to simulate the texture for the surface.
